(19) United States
(12) Patent Application Publication
(10) Pub. No.: US 2009/0015066 A1
(43) Pub. Date: Jan. 15, 2009

(54) CLOSE-LOOP RELAY DRIVER WITH EQUAL-PHASE INTERVAL

(75) Inventors: Sam Yonghong Guo, Canton, MI (US); Richard P. Cuplin, Canton, MI (US)

Correspondence Address: HARNESS, DICKEY & PIERCE, P.L.C., P.O. BOX 828, BLOOMFIELD HILLS, MI, 48303, US

(73) Assignee: Yazaki North America, Inc., Canton, MI (US)

(21) Appl. No.: 11/775,588

(22) Filed: Jul. 10, 2007

(51) Int. Cl. H01H 47/14; B60K 8/00; H02J 1/00; H01H 47/00

(52) U.S. Cl. 307/31; 180/54.1; 361/166; 361/191

(57) ABSTRACT

A power distribution system generally includes at least two relays. An equal-phase pulse generator generates pulse signals in equal phase intervals. At least two drivers, one for each of the at least two relays, control current flow to the at least two relays based on the pulse signals.

### FIELD

The present disclosure relates to methods and systems for controlling current to mechanical relays.

### BACKGROUND

Coils in mechanical relays generate heat. When a relay is activated, the relay needs large current to pull in the armature. Once the armature is pulled in, only a small current is needed to hold the armature in place.

Pulse width modulated (PWM) relay driver systems can reduce coil power consumption and associated heat dissipation significantly. However, in PWM driving circuits, the power supply current (driving current) is discontinuous. In automobile body control modules, there can be many relays in one system. The sum of the discontinuous current results in large discontinuous current. To compensate for the discontinuous current, filters can be implemented to smooth the driving current. Generally, two stages of band-pass filters, each including an inductor and a capacitor, are needed. Since inductors are expensive, two stages of band-pass filters increase the system cost.

### SUMMARY

The present teachings generally include a power distribution system. The power distribution system generally includes at least two relays. An equal-phase pulse generator generates pulse signals in equal phase intervals. At least two drivers, one for each of the at least two relays, control current flow to the at least two relays based on the pulse signals.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram illustrating a vehicle including a power distribution system in accordance with various aspects of the present teachings.

FIG. 2 is a block diagram illustrating a relay driver system of the power distribution system in accordance with various aspects of the present teachings.

FIG. 3 is a graph illustrating exemplary current values and an exemplary total current value generated by the relay driver system in accordance with various aspects of the present teachings.

FIG. 4 is a block diagram illustrating an equal-phase pulse generator of the relay driver system in accordance with various aspects of the present teachings.

FIG. 5 is an electrical schematic diagram illustrating an exemplary equal-phase pulse generator of the relay driver system in accordance with various aspects of the present teachings.

FIG. 6 is a block diagram illustrating an exemplary driver of the relay driver system in accordance with various aspects of the present teachings.

FIG. 7 is an electrical schematic diagram illustrating an exemplary driver of the relay driver system in accordance with various aspects of the present teachings.

### DETAILED DESCRIPTION

The following description is merely exemplary in nature and is not intended to limit the present teachings, their application, or uses. It should be understood that throughout the drawings, corresponding reference numerals indicate like or corresponding parts and features. As used herein, the term, component and/or device can refer to one or more of the following: an application specific integrated circuit (ASIC), an electronic circuit, a processor (shared, dedicated or group) and memory that executes one or more software or firmware programs, a combinational logic circuit and/or other suitable mechanical, electrical or electromechanical components that can provide the described functionality and/or combinations thereof.

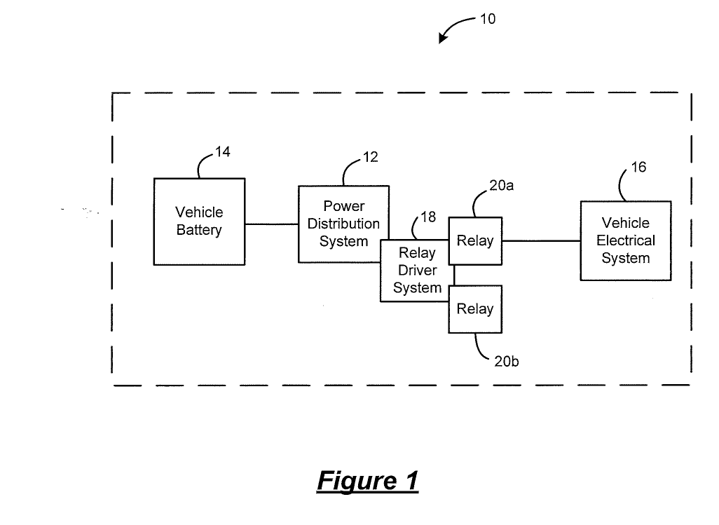

FIG. 1 illustrates a vehicle generally at 10 that can include a power distribution system 12. The power distribution system 12 can provide electrical energy from a vehicle battery 14 to various electrical systems 16 of the vehicle 10. The power distribution system 12 can include one or more instances of a relay driver system 18 that can control the flow of current to operate at least relays 20a and 20b. According to various aspects of the present teachings, the relay driver system 18 can control the total supply of current to the relays 20a and 20b.

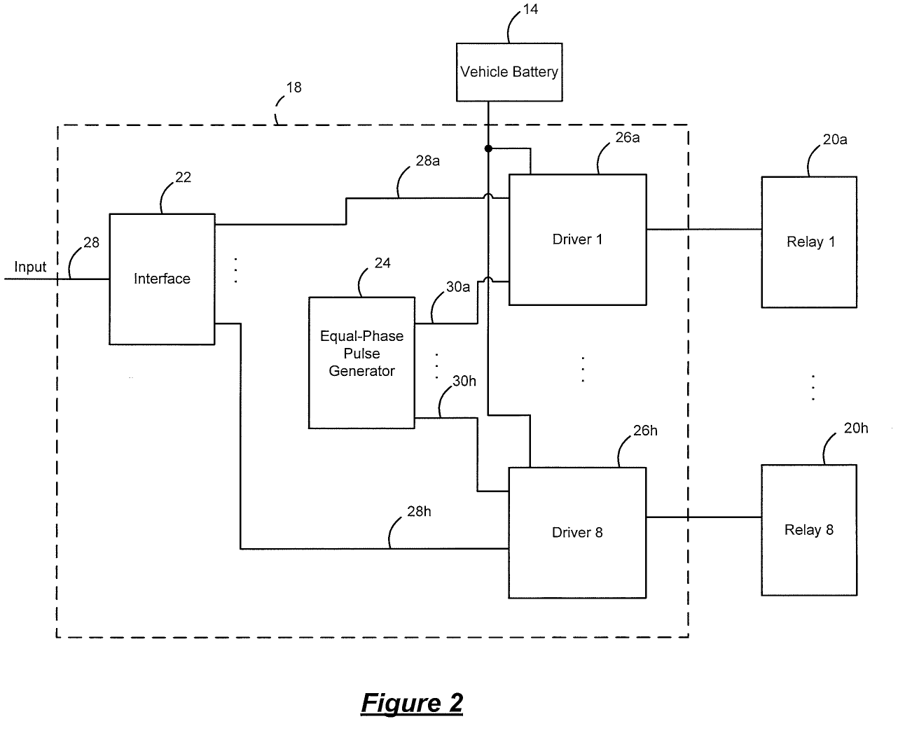

With reference to FIG. 2 and in various aspects of the present teachings, as discussed above, the relay driver system 18 can control the flow of current to operate at least two relays 20a and 20b. As can be appreciated in light of the present teachings, the relay driver systems and methods of the present disclosure can control the flow of current to operate multiple relays. FIG. 2 illustrates a relay driver system that can control the flow of current to operate eight relays 20a-20h. For ease of the discussion, the remainder of the disclosure will be discussed in the context of the relay driver system 18 that can control eight relays 20a-20h.

As shown in FIG. 2, the relay driver system 18 can include one or more components such as an interface 22, an equal-phase pulse generator 24, drivers 26a-26h, one for each of the relays 20a-20h, and/or combinations thereof. The interface 22 can communicate with other systems of the vehicle 10 (FIG. 1). The interface 22 can receive and can process input signals (generally referred to as 28) that request operation of the relays 20a-20h. The interface 22 can direct the input signal 28a-28h to the appropriate the drivers 26a-26h. The equal-phase pulse generator 24 can generate a pulse signal 30a-30h to each of the drivers 26a-26h. According to various aspects of the present teachings, the equal-phase pulse generator 24 can generate the pulse signals 30a-30h in equal phase intervals. For example, provided eight drivers 26a-26h and three hundred sixty degrees of electrical angle, a pulse signal 30a-30h can be generated every forty-five degrees. As can be appreciated in light of the present teachings, the phase interval of the pulse signals 30a-30h can vary depending on the number of drivers 26a-26h and thus, the number of relays 20a-20h.

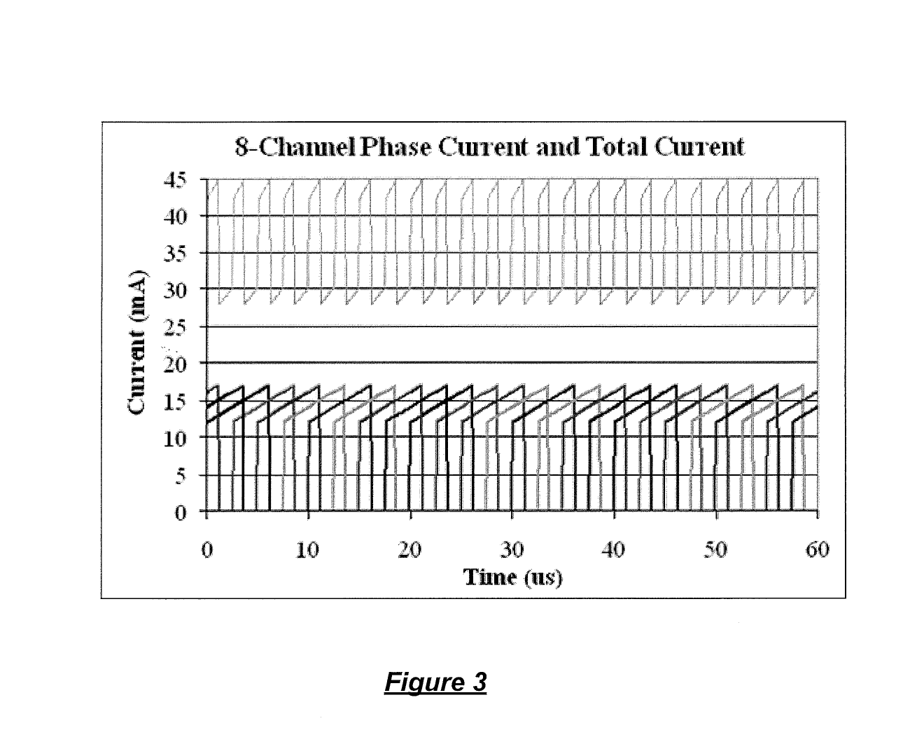

The drivers 26a-26h can receive the corresponding pulse signals 30a-30h and the related input signals 28a-28h. Based on the pulse signals 30a-30h and the input signals 28a-28h, the drivers 26a-26h can regulate the flow of current from the vehicle battery 14 to the relays 20a-20h. According to various aspects of the present teachings, the drivers 26a-26h can regulate the flow of current such that the current to each relay can be discontinuous. However, the supply of current to each relay can lag the previous relay by the phase interval, for example forty-five degrees, thus, the total supply of current supplied by the relay driver system 18 can be distributed as shown in FIG. 3. Furthermore, the total supply of current supplied at any one time can be significantly reduced.

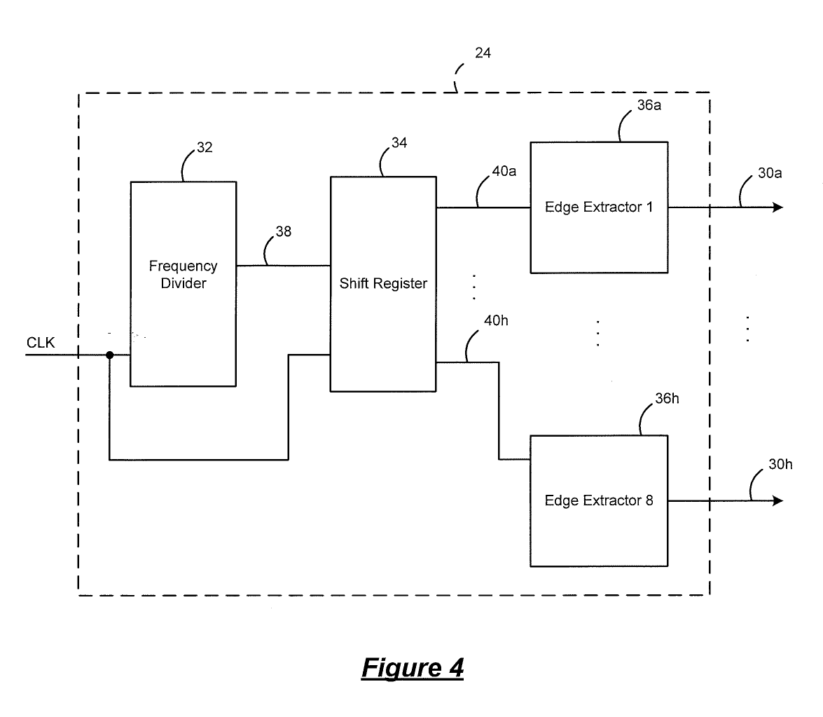

With reference to FIG. 4 and in various aspects of the present teachings, as discussed above, the equal-phase pulse generator 24 can generate pulse signals 30a-30h according to equal phase intervals. As shown in FIG. 4, the equal-phase pulse generator 24 can include components such as a frequency divider 32, a shift register 34, two or more edge extractors 36a-36h, one for each of the drivers 26a-26h (FIG. 2), and/or combinations thereof. The frequency divider 32 can generate an output signal 38 in equal phase intervals. In one example, the frequency divider 32 can be implemented as a general purpose counter configured to operate as a frequency divider. As can be appreciated in light of the present teachings, the phase interval can be determined based on a division ratio.

The output signal 38 of the frequency divider 32 can be received by the shift register 34. Based on the output signal 38, the shift register 34 can generate drive signals to each of the edge extractors 36a-36h. Drive signals 40a-40b generated by the shift register 34 are of equal phase intervals. The edge extractors 36a-36h can then generate the pulse signals 30a-30h by extracting a rising edge of the drive signals 40a-40b generated by the shift register 34.

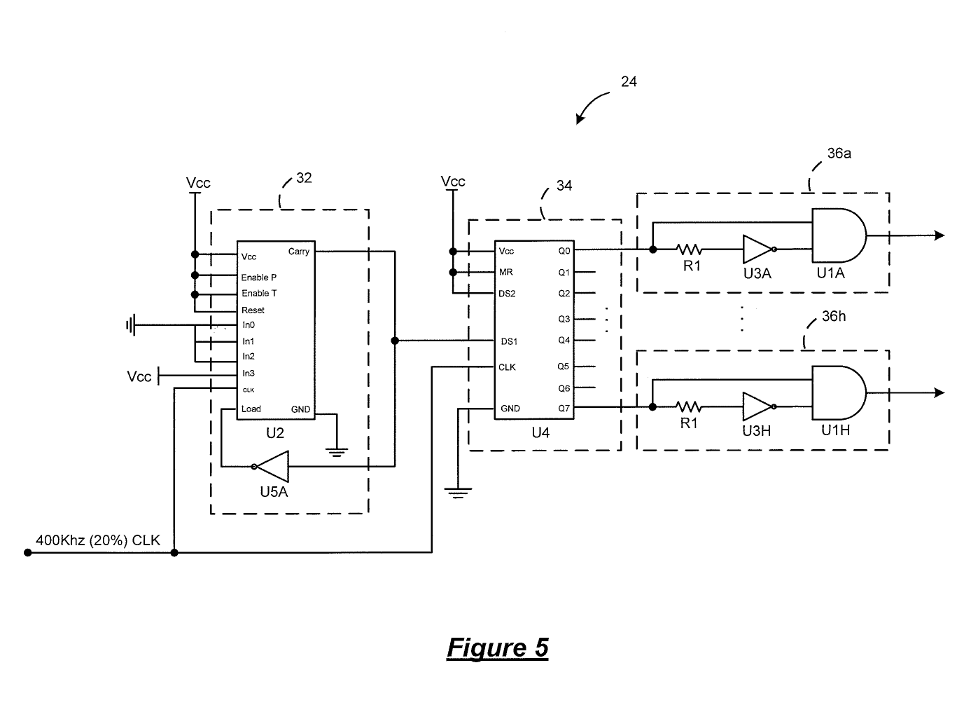

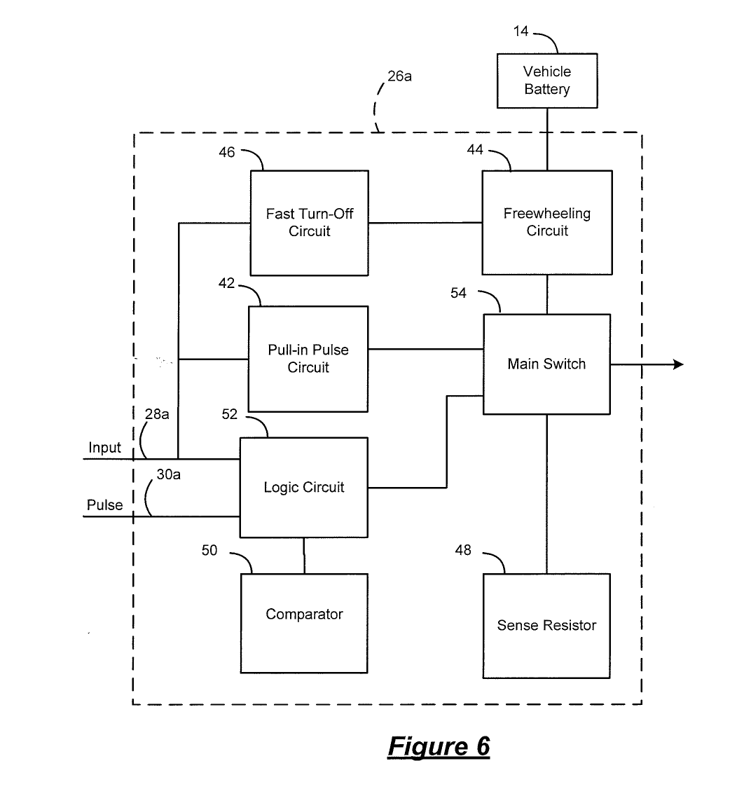

With reference to FIG. 5, an electrical schematic diagram illustrates an example of the equal-phase pulse generator 24 including eight channels shown in FIG. 4. As shown in FIG. 5, the frequency divider 32 can include a counter U2 and an inverter U5A. For every eight clocks, there can be one output signal at Carry terminal. The Carry signal can be fed back to the Load input through U3C to reset the counter for another eight clock counting. The Carry signal can also be sent to the input of shift register 34 (DS1). This signal can then be shifted out from Q0 to Q7 clock by clock. As a result, signals on Q0 to Q7 can be of equal time interval or equal phase interval. The time interval can be the clock period. The phase interval can be 360°/8=45°. Each edge extractor 36a-36h can include a resistor R1, an inverter U3A, and a logic gate U1A. Each edge extractor 36a-36h can receive signals from Q0 to Q7. On the rising edge, an edge extractor 36a-36h can output a short pulse for triggering purposes of a main switch 54 (shown in FIG. 6).

With reference to FIG. 6 and continued reference to FIG. 2 and in various aspects of the present teachings, the drivers 26a-26h can control the flow of current to the relays 20a-20h based on the pulse signals 30a-30h. In one aspect of the present teachings, the drivers 26a-26h can control the current flow to provide a full battery voltage to the relays 20a-20h during an initial pull-in period (i.e., moving an armature of the relay). In another aspect of the present teachings, after the pull-in period (i.e., a period in which the position of the armature can be maintained), the current flow can be regulated such that a position of the armature of the relays 20a-20h can be maintained without utilizing excess electrical energy and/or creating excess heat.

The driver 26a shown in the example of FIG. 6 can generally include a pull-in pulse circuit 42, a freewheeling circuit 44, a fast turn-off circuit 46, a sense resistor 48, a comparator 50, a logic circuit 52, a main switch 54, and/or combinations thereof. For ease of the discussion, the drivers 26a-26h will be discussed in the context of the driver 26a as shown in FIG. 6.

As discussed above, the driver 26a can receive the input signal 28a and the pulse signal 30a. Based on the input signal 28a and the pulse signal 30a, the driver 26a can control an armature of the relay 20a while minimizing the dissipation of heat. According to various aspects of the present teachings, the current can flow from the vehicle battery 14 through various paths within the driver 26a to the relay 20a.

More particularly, at the beginning of relay operation, the pull-in pulse circuit 42 can generate a pull-in pulse for a time at which it takes to pull in the armature of the relay 20a. Thereafter, the logic circuit 52, the sense resistor 48, the comparator 50, and/or combinations thereof can control the state of the main switch 54 to be ON or to be OFF. When the main switch 54 is ON, current flows from the vehicle battery 14 to the relay 20a. When the main switch 54 becomes OFF, the flow of current can be discharged by the freewheeling circuit 44, the fast turn-off circuit 46, and/or combinations thereof.

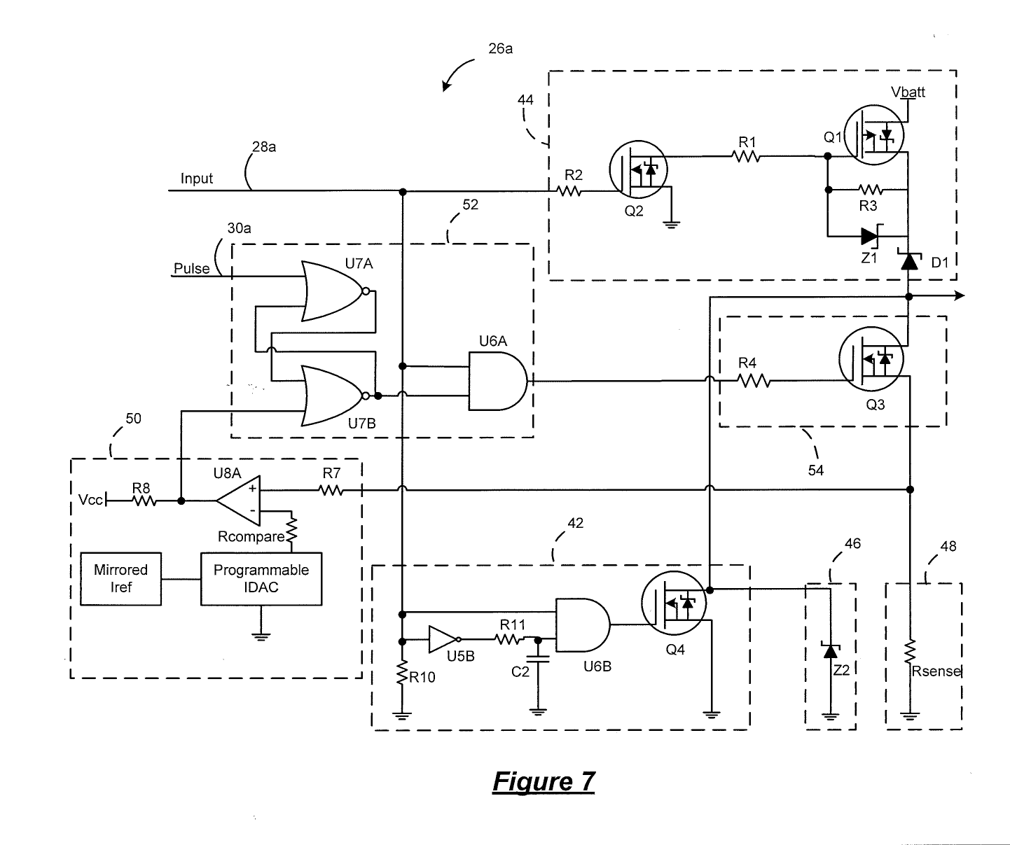

With reference to FIG. 7, an electrical schematic diagram illustrates an example of various aspects of the driver 26a shown in FIG. 6. The pull-in pulse circuit 42 can include an inverter U5B, a first resistor R10, a second resistor R11, a capacitor C2, an AND gate U6B, and a pull-in transistor Q4. The freewheeling circuit 44 can include a first resistor R1, a second resistor R2, a third resistor R3, a first transistor Q2, a second transistor Q1, a diode D1, and a Zener diode Z1. The fast turn-off circuit 46 can include a Zener diode Z2. The sense resistor 48 can include a sense resistor Rsense. The comparator 50 can include a first resistor R7, a comparator resistor Rcompare, a third resistor R8, a comparator U8A, a programmable IDAC, and a Mirrored Iref. The logic circuit 52 can include a first NOR gate U7A, a second NOR gate U7B, and an AND gate U6A. The main switch 54 can include a resistor R4 and a main switch Q3.

As can be appreciated in light of the present teachings, the driver 26a, as shown in FIG. 7, can operate according to the following methods. When the input signal 28a is high, the pull-in pulse circuit 42 can generate a pulse, for example for twenty milliseconds, by turning ON the pull-in transistor Q4. A large pull-in current can flow from Vbatt, through the coil of the relay 20a, through the pull-in transistor Q4, and on to GND. At the same time, the transistor Q2 and the transistor Q1 of the freewheeling circuit 44 can be turned ON and can remain ON until the input signal 28a becomes low. After the armature of the relay 20a is pulled in, the transistor Q4 can be turned OFF and the coil current can be regulated to a small value to hold the armature of the relay 20a in place.

The current regulation can be a close-loop regulation. For example, when coil current is low, Q3 can be turned on by the equal-phase pulse signal 30a through the NOR gate U7A and the AND gate U6A. The coil current of the relay 20a can ramp up. When coil current increases above a threshold set by the comparator resistor Rcompare and the Programmable IDAC, the main switch Q3 can be turned off by the comparator U8A through the NOR gate U7B and the AND gate U6A. After the main switch Q3 is turned OFF, coil current of the relay 20a can ramp down through the diode D1 and the transistor Q1 to the coil itself. This current can be referred to as freewheeling current. When a next equal-phase pulse signal 30a is generated, the main switch Q3 can be turned ON again and the procedure can repeat.

When the input signal 28a becomes low, the transistor Q2, the transistor Q1, and the main switch Q3 can be turned OFF. The coil current of the relay 20a can be discharged through the Zener diode Z2 at a high voltage. The coil current can decay rapidly and the relay contacts can separate rapidly.

While specific aspects have been described in this specification and illustrated in the drawings, it will be understood by those skilled in the art that various changes can be made and equivalents can be substituted for elements thereof without departing from the scope of the present teachings, as defined in the claims. Furthermore, the mixing and matching of features, elements and/or functions between various aspects of the present teachings may be expressly contemplated herein so that one skilled in the art will appreciate from the present teachings that features, elements and/or functions of one aspect of the present teachings may be incorporated into another aspect, as appropriate, unless described otherwise above. Moreover, many modifications may be made to adapt a particular situation, configuration or material to the present teachings without departing from the essential scope thereof. Therefore, it is intended that the present teachings not be limited to the particular aspects illustrated by the drawings and described in the specification as the best mode presently contemplated for carrying out the present teachings but that the scope of the present teachings will include many aspects and examples following within the foregoing description and the appended claims.

What is claimed is:

1. A power distribution system, comprising:
at least two relays;
an equal-phase pulse generator that generates pulse signals in equal phase intervals; and
at least two drivers, one for each of said at least two relays, that control current flow to said at least two relays based on said pulse signals.

2. The system of claim 1 wherein said equal-phase pulse generator includes a frequency divider that generates an output signal at equal phase intervals.

3. The system of claim 2 wherein said equal-phase generator includes a shift register that generates at least two drive signals.

4. The system of claim 3 wherein said equal-phase generator includes at least two edge extractors, one for each of said at least two relays, that generate said pulse signals by extracting a rising edge of said at least two drive signals.

5. The system of claim 1 wherein at least one of said at least two drivers includes a pull-in pulse generator that generates an initial pull-in pulse when an input signal indicates a first state.

6. The system of claim 1 wherein at least one of said at least two drivers includes a freewheeling circuit that regulates said current flow when a voltage of said current flow exceeds a predetermined threshold.

7. The system of claim 6 wherein said at least one of said at least two drivers further includes:
a sense resistor that senses said voltage of said current flow;
a comparator that performs a comparison of said voltage and said predetermined threshold; and
a logic circuit that controls said current flow to said freewheeling circuit based on said pulse signal and said comparison of said voltage and said predetermined threshold.

8. The system of claim 1 wherein at least one of said at least two drivers includes a fast turn-off circuit that discharges current from said relay when an input signal indicates a second state.

9. A method of controlling current flow to at least two relays of a power distribution system, the method comprising:
generating at least two equal-phase pulse signals based on a phase interval;
controlling current flow to a first relay based on a first equal-phase pulse signal of said at least two equal-phase pulse signals; and
controlling current flow to a second relay based on a second equal-phase pulse signal of said at least two equal-phase pulse signals.

10. The method of claim 9 further comprising momentarily initiating a pull-in pulse signal when an input signal indicates a first state.

11. The method of claim 10 further comprising discharging current when said input signal changes to a second state.

12. The method of claim 9 further comprising:
for at least one of said first relay and said second relay:
monitoring a relay coil current; and
comparing said relay coil current to a predetermined threshold, wherein when said relay coil current exceeds said predetermined threshold, regulating said current flow to said at least one of said first relay and said second relay to reduce coil heat.

13. A vehicle, comprising:
a vehicle battery; and
a power distribution system that regulates current flow to at least two relays based on pulse signals generated in equal intervals, wherein a total current flow to said at least two relays is distributed.

14. The vehicle of claim 13 wherein said power distribution system regulates said current flow to said at least two relays by:
generating at least two equal-phase pulse signals based on a phase interval;
controlling current flow to a first relay based on a first equal-phase pulse signal of said at least two equal-phase pulse signals; and
controlling current flow to a second relay based on a second equal-phase pulse signal of said at least two equal-phase pulse signals.

15. The vehicle of claim 13 wherein said power distribution system regulates said current flow to said at least two relays by momentarily initiating a pull-in pulse signal when an input signal indicates a first state.

16. The vehicle of claim 14 wherein said power distribution system regulates said current flow to said at least two relays by discharging current when said input signal changes to a second state.

17. The vehicle of claim 14 wherein said power distribution system regulates said current flow to said at least two relays by:
monitoring a relay coil current; and
comparing said relay coil current to a predetermined threshold, wherein when said relay coil current exceeds said predetermined threshold, regulating said current flow to said at least one of said first relay and said second relay to reduce coil heat.
